(19) United States
(12) Patent Application Publication
(10) Pub. No.: US 2010/0083324 A1
(43) Pub. Date: Apr. 1, 2010

(54) Synchronized Video Playback Among Multiple Users Across A Network

(75) Inventors: Derek Smith, Snohomish, WA (US); Kendall Ryan Davis, Oakland, CA (US); John Ikeda, Seattle, WA (US); Shaheen Gandhi, Seattle, WA (US); Dan B. Kroymann, Bothell, WA (US); Justin Nordin, Houston, TX (US); Dale Murchie, Redwood, WA (US); Lee Jason Schuneman, Warwickshire (GB); Nicholas Robert Makin, Debyshire (GB); Ian Charles Bolton, Leicestershire (GB); Jerry Johnson, Medina, WA (US); Richard Irving, Kirkland, WA (US); Paul James Lukinich, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/241,426

(22) Filed: Sep. 30, 2008

(51) Int. Cl. H04N 7/173

(52) U.S. Cl. 725/109

(57) ABSTRACT

Synchronized video playback among multiple users across a network provides a fully social experience where people in different locations may be enabled to watch the same video in a “virtual living room.” The users may be represented graphically, as avatars, in front of the video, and may be enabled to use animations, text chat, and voice chat to interact with each other. Thus, a group of people may be enabled to share the experience of watching a video together as if they were in the same room, without being physically present together.

### BACKGROUND

Networked multiplayer gaming is generally available on both personal computers (“PCs”) and game consoles. Networked, social multimedia experiences, such as streaming video, for example, are not. It would be desirable to provide a synchronized, multimedia experience for a group of people that are not physically located in the same place. It would be particularly desirable if such an experience were to include multiparty text and voice chat, and virtual user avatars.

An avatar can represent a user in a variety of contexts, including computer or video games, applications, chats, forums, communities, and instant messaging services. An avatar can be thought of as an object representing the embodiment of a user and may represent various actions and aspects of the user's personal, beliefs, interests, or social status.

Some avatars can be customized by the user in a variety of ways relating to the appearance of the avatar. For example, in some video game systems, the user can customize the facial features, hair style, skin tone, body build, clothing, and accessories of the avatar. As a particular example, the WII® video gaming system, available from Nintendo of America headquartered in Redmond, Wash., features a user-created, system-wide avatar known as the MII®, which a user may use as his or her user-controlled character in video games that support this feature, such as WII SPORTS®.

### SUMMARY

A “social video application” may designate one of a party of client computers as a “remote holder.” The remote holder may be the first member of the party to request a network session, such as a request for streaming video. The remote holder may then invite other clients to establish a networked, social multimedia experience.

The remote holder may have control over a shared “remote control” that controls content playback. The video may be kept synchronized by keeping all users updated on the remote holder's state. If a user's state is different from that of the remote holder, it may be updated. Users may also be enabled to make requests of the remote holder by sending the remote holder and all other users an updated state that differs from the remote holder's state. Any member may be promoted to remote holder, demoting the current remote holder to a normal user. The server may keep track of the identify of the current remote holder.

A fully social experience may be created where people are not only watching the same video, but also using graphical user avatars to create a “virtual living room.” The users may be represented graphically in front of the video, and may be enabled to use animations, text chat, and voice chat to interact with each other. Thus, a group of people may be enabled to share the experience of watching a video together as if they were in the same room, without being physically present together.

### BRIEF DESCRIPTION OF THE DRAWINGS

FIG. 1 is a block diagram of an example network configuration.

FIG. 2 depicts an example user interface that maybe provided during a networked, social multimedia experience.

FIGS. 3A-3C are flowcharts of example methods for synchronizing control commands in a networked, social multimedia environment.

FIG. 4 is a block diagram of an example computing environment.

### DETAILED DESCRIPTION OF ILLUSTRATIVE EMBODIMENTS

### Network Environment

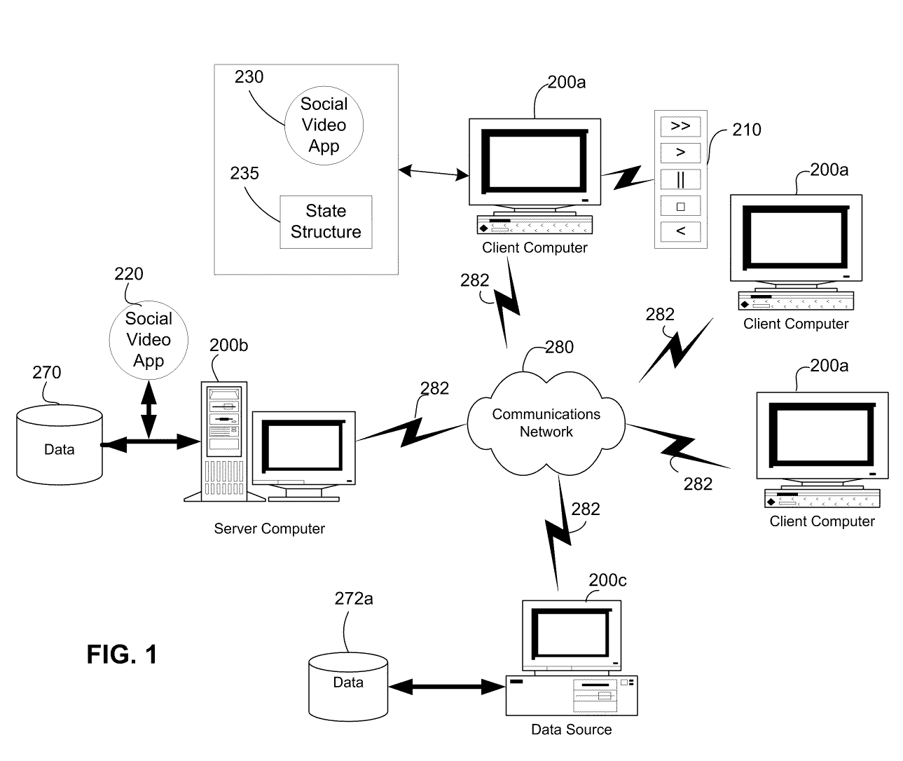

FIG. 1 illustrates an example network environment. Of course, actual network and database environments may be arranged in a variety of configurations; however, the example environment shown here provides a framework for understanding the type of environment in which an embodiment may operate.

The example network may include one or more client computers 200a, a server computer 200b, data source computers 200c, and/or databases 270, 272a, and 272b. The client computers 200a and the data source computers 200c may be in electronic communication with the server computer 200b by way of the communications network 280 (e.g., an intranet, the Internet or the like). The client computers 200a and data source computers 200c may be connected to the communications network by way of communications interfaces 282. The communications interfaces 282 can be any type of communications interfaces such as Ethernet connections, modem connections, wireless connections and so on.

The server computer 200b may provide management of the database 270 by way of database server system software such as MICROSOFT®'s SQL SERVER or the like. As such, server 200b may act as a storehouse of data from a variety of data sources and provides that data to a variety of data consumers.

In the example network environment of FIG. 1, a data source may be provided by data source computer 200c. Data source computer 200c may communicate data to server computer 200b via communications network 280, which may be a LAN, WAN, Intranet, Internet, or the like. Data source computer 200c may store data locally in database 272a, which may be database server or the like. The data provided by data source 200c can be combined and stored in a large database such as a data warehouse maintained by server 200b.

Client computers 200a that desire to use the data stored by server computer 200b can access the database 270 via communications network 280. Client computers 200a access the data by way of, for example, a query, a form, etc. It will be appreciated that any configuration of computers may be employed.

The client computers 200a depicted in FIG. 1 may be PCs or game consoles, for example. Two or more clients 200a may form a “party.” A “social video application” 220 running on the server 200b may designate one of the clients 200a as the “remote holder.” The remote holder may be the first member of the party to request a network session. Such a request may be, for example, a request for streaming video. The remote holder may then invite other clients to establish a networked, social multimedia experience, i.e., to join the party.

The remote holder may have control over a shared “remote control” 210 that controls content playback. When the remote holder presses play, pause, reverse, or fast-forward, for example, the remote holder's “state” may be sent to all connected users in a group, who see it and synchronize to it, causing the same action to occur on their client. The other users may have the ability to play, pause, and request remote holder status by sending their own state to the remote holder. Such actions may need approval from the current remote holder to take effect. Users may also have the ability to leave the playback session.

The video may be kept synchronized by keeping all users updated on the remote holder's state. The remote holder's state may be a structure 235 that contains information on playback status (e.g., playing, paused, initializing, etc.), an identifier associated with the content being viewed, and a current time code associated with the content. The remote holder may maintain its state (i.e., keep it up-to-date), and send it to all the other users when it changes. The other users may then see the new state, compare their own time code and playback state to the remote holder's, and then take action accordingly. Each client may have its own respective social video application 230, and may maintain its own respective state structure 235.

If a user's state is different from that of the remote holder, it may be updated (playing may become paused, for example). If a user's time code is too different from the remote holder's, then a “seek” operation may be performed to the remote holder's reported time code. The user may be responsible for predicting, based on “pre-buffering times,” how long it will take the seek call to complete, and compensate by adjusting the targeted time code.

Users may also be enabled to make requests of the remote holder by sending the remote holder and all other users an updated state that differs from the remote holder's state. When the remote holder sees this state, it may be taken as a request. The remote holder may update its state to reflect the requested changes. Only then do the other users (including the user that made the request) change their state. The same process can be used to request remote holder status.

In an example embodiment, any user can be the remote holder, but only one user can be the remote holder at any time. Any member may be promoted to remote holder, demoting the current remote holder to a normal user. The “current” remote holder is the only user who can “pass the remote” to another user. The server may keep track of the identify of the current remote holder.

Multiparty voice chat may be integrated into the experience, allowing members to comment on the video. Thus, a group of people may be enabled to share the experience of watching a video together as if they were in the same room, without being physically present together. All users may have the same access to voice chat. That is, any user may speak whenever he chooses.

Multiparty voice chat may require a certain level of synchronization among the clients that form the party. If any client were allowed to be even a few seconds out of synch with the rest of the party, comments made over the chat may not make sense. Additionally, feedback from the audio of one client sent over voice chat could be very disruptive if it's not closely in-sync with what other users are hearing from their own video.

Fast-forward and reverse may be treated differently from play, pause, and seek commands. When the remote holder elects to fast-forward or reverse, the other clients may simply pause playback. When the remote holder finds the time in the video from which playback should resume, the other clients may receive the remote holder's updated state, and issue a “seek” command telling them to resume playback from the time index the remote holder has selected. This may eliminate potential synchronization issues that may be caused by fast-forward or reverse speeds being slightly different on different users' client computers.

A fully social experience may be created where people are not only watching the same video, but also using graphical user avatars to create a “virtual living room.” The users may be represented graphically in front of the video, and may be enabled to use animations, text chat, and voice chat to interact with each other.

For example, the introduction of graphical avatars into the shared video experience may add another dimension to the experience by giving users a sense of identity within the virtual living room. Each user watching the video may be represented by their own customized avatar. The avatars of every person in the session may be rendered on everyone else's television or monitor, resulting in a group of avatars that appear to be watching the video in a virtual environment. Each user may be enabled to trigger animations and text messages (in the form of “speech balloons,” for example) for their avatar. Such animations and text messages may be rendered on every other users' television or monitor.

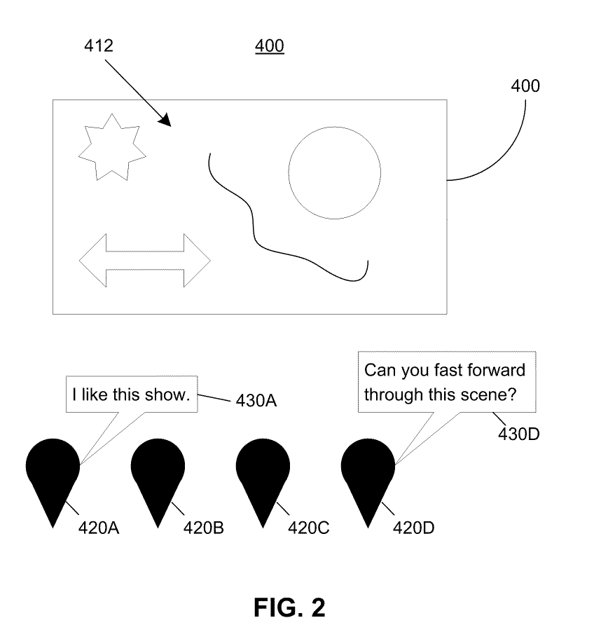

FIG. 2 depicts an example user interface 400 that maybe provided during a networked, social multimedia experience. The user interface 400 may be presented on respective video monitors provided at each client location. The same interface may be presented at each location.

In general, the user interface 400 depicts a “virtual living room.” Specifically, as shown in FIG. 2, the user interface 400 may include a video presentation portion 410, via which the video 412 is presented to the users. The user interface 400 may also include a respective avatar 420A-D corresponding to each of the users. The user interface 400 may also include a text chat area. As shown, text chat may be presented in the form of speech balloons 430A,D. Alternatively or additionally, text chat may be presented as scrolling text in a chat box portion of the user interface 400. Audio maybe presented via one or more speakers (not shown) provided at the client locations.

Each client may render its own living room. Thus, software may be provided on each client to enable the client to render its own living room. The living rooms rendered on the several clients may be identical, or not.

When a user causes his or her avatar to gesticulate, the gesture may be presented at all the client locations in synchronicity. Similarly, when a user speaks or otherwise produces an audio event, e.g., through voice chat, or textual event, e.g., through text chat, the audio or text may be presented at all the client locations in synchronicity.

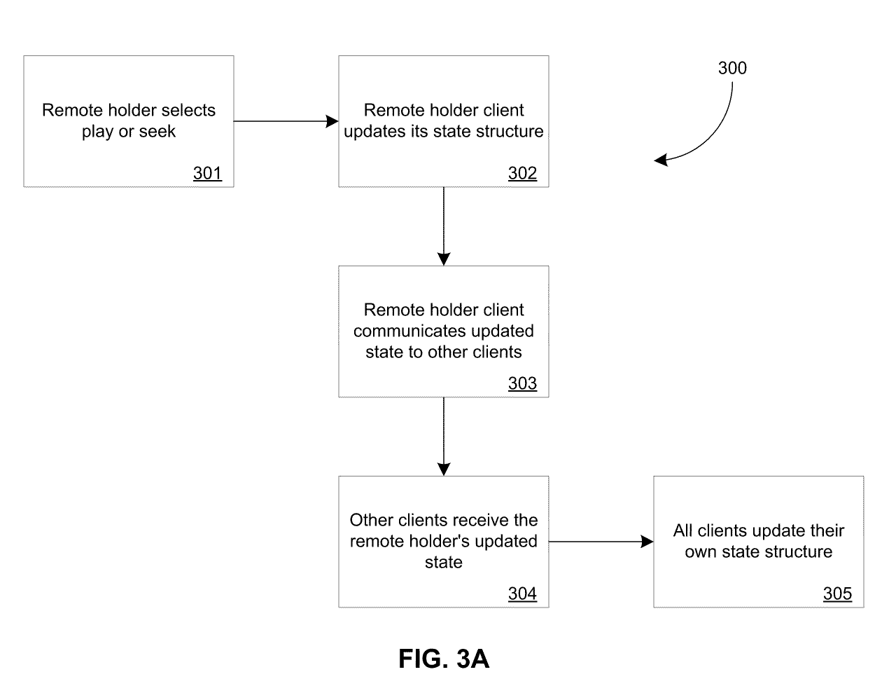

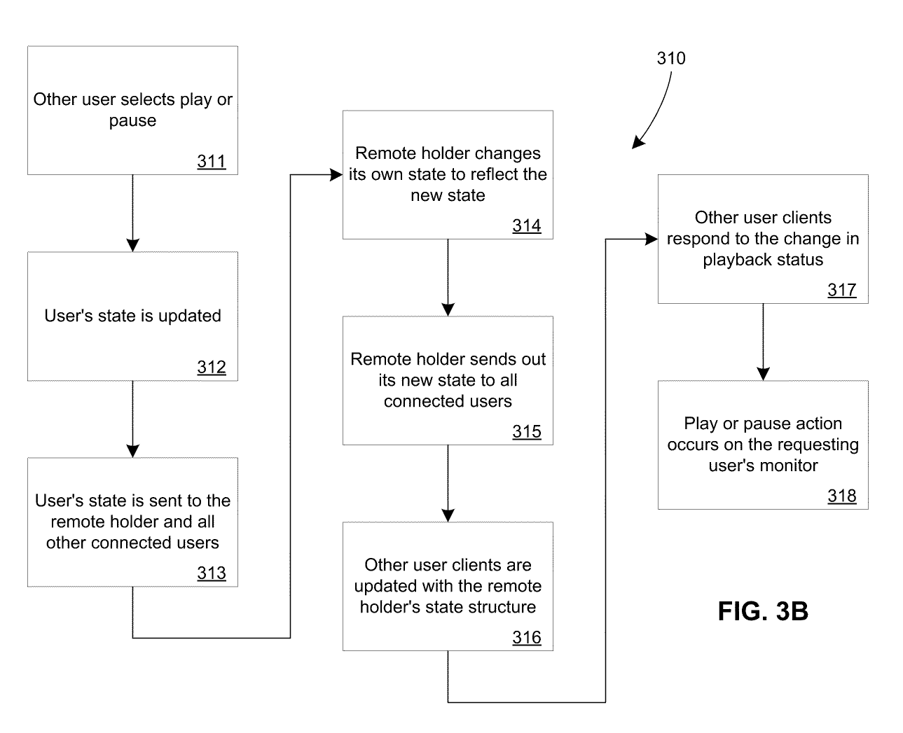

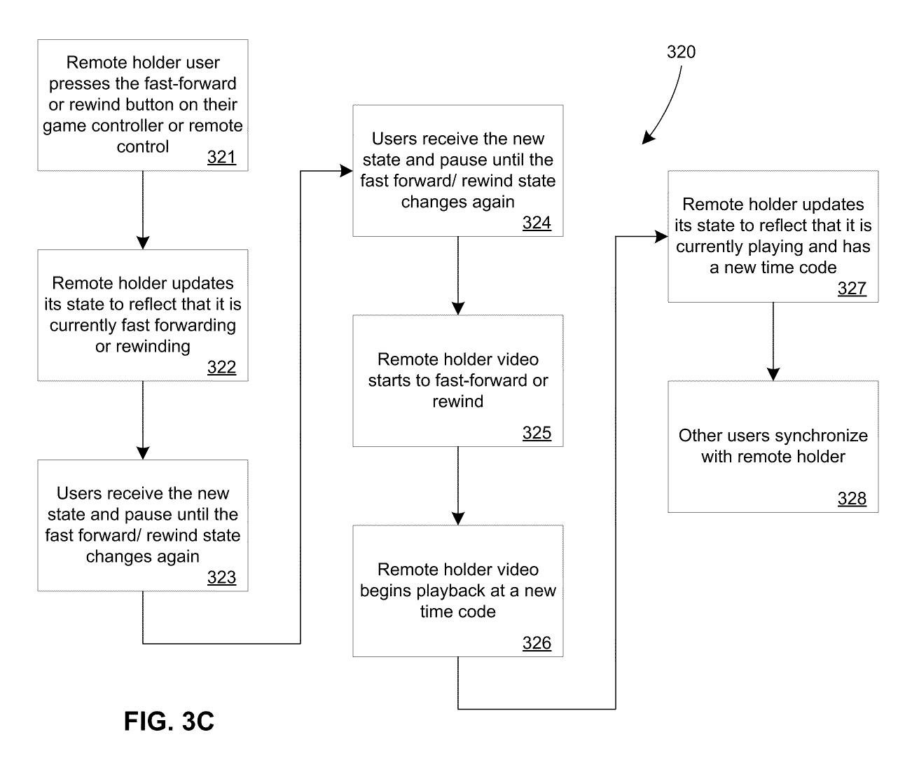

FIG. 3A is a flowchart of an example method 300 for synchronizing play, pause, stop, and seek commands from the remote holder. At 301, the remote holder may select a “play,” “pause,” “stop,” or “seek” operation, e.g., by pressing the play, pause, stop, or seek button on their game controller or remote control. At 302, in response to the remote holder's selection of the play, pause, stop, or seek operation, the remote holder client may update its state structure to reflect the change in time code and playback status.

At 303, the remote holder client communicates the remote holder's state structure to the other clients in the party. To maintain the highest level of synchronization among the several clients in the party, such updates should be communicated as frequently as possible. At 304, the other clients receive the remote holder's updated state. At 305, each client responds to the state change by updating its own state structure to conform to that of the remote holder.

The state structure from each client may be sent to every other client, so that every client always knows the current state of every other client in the party. Because the state structure contains information on playback status, an identifier associated with the content being viewed, and a current time code associated with the content, each client will then be performing the same operation, at the same place in the same content, at the same time.

FIG. 3B is a flowchart of an example method 310 for synchronizing play or pause commands from a user who is not the remote holder. In an example embodiment, a user who is not the remote holder is not enabled to exercise a stop, seek, fast-forward, or reverse command. At 311, a non-remote holder user may select a “play” or “pause” operation, e.g., by pressing the play or pause button on their game controller or remote control. At 312, in response to the user's selection of the play or pause operation, the selecting user's client may update its state structure to reflect that a play or pause state has been requested.

At 313, the selecting user's client may send the selecting user's state to the remote holder client, as well as to all other members of the party. At 314, the remote holder client may receive the selecting user's state, from which it can determine that another member of the party has made a playback state change request. The remote holder client may change its own state to reflect the new state.

At 315, the remote holder client communicates the remote holder's state structure to the other clients in the party. To maintain the highest level of synchronization among the several clients in the party, such updates should be communicated as frequently as possible. At 316, the other clients receive the remote holder's updated state.

At 317, the other clients, including the user who made the original request, receive the remote holder's updated state, and respond to the state change by updating their own state structures to conform to that of the remote holder. At 318, the selected action occurs on the requesting user's client.

FIG. 3C is a flowchart of an example method 320 for synchronizing fast-forward and reverse commands from the remote holder. At 321, the remote holder may select a “fast-forward” or “reverse” operation, e.g., by pressing the fast-forward or reverse button on their game controller or remote control.

At 322, in response to the remote holder's selection of the fast-forward or reverse operation, the remote holder client may update its state to reflect that it is currently fast-forwarding or reversing. At 323, the remote holder client communicates the remote holder's state structure to the other clients in the party. At 324, the other users receive the new state, and pause until the fast forward/reverse state changes again.

At 325, the remote holder video starts to fast-forward or reverse. Eventually, the remote holder may select a “play” operation, e.g., by pressing the play button on their game controller or remote control. At 326, the remote holder video begins playback at the time code associated with the point in the video at which the remote holder selected the play operation.

At 327, the remote holder may update its state to reflect that it is currently playing and has a new time code, and communicate its state structure to the other clients in the party. At 328, the other users receive the new state structure and perform a seek and play operation to get back synchronized with the remote holder.

Thus, the remote holder may be allowed full control over the virtual remote control, while the other users have only the ability to exit the video experience, play, pause, and make requests of the remote holder. In an example embodiment, no playback changes are made until the remote holder has changed its own state.

Synchronization of avatars may be implemented in much the same way as described above in connection with synchronization of play and pause commands. Each user would construct his or her own avatar, or retrieve a saved avatar if the user already constructed one. Each client could then communicate information about its respective avatar to the other clients.

As each client renders its respective living room, it may retrieve the avatars from a common server (e.g., based on gamer tags associated with the avatars). For example, avatars may be retrieved via the internet. Avatar placement and emotion information may be contained in the state structure that is passed around the several users. Placement information may indicate where each avatar is to be presented in the user interface, either in absolute or relative terms. Emotion information may convey an emotional state. Each client may animate a certain avatar based on emotion information received for that avatar. Thus, when rendering its virtual living room, each client can determine from the state structure what the virtual living room is supposed to look like, avatar placement therein, which avatar is speaking, gesturing, leaving, etc.

Synchronized text chat may also be implemented in much the same way as described above in connection with synchronization of play and pause commands. Text provided by one user may be included in the state structure that is passed around the several users.

Voice chat can be implemented via the so-called “party” system, which connects up to eight users together. In essence, the party system employs a respective gamer tag associated with each of the several users. Thus, synchronized voice chat may be built into the system, eliminating any need to convey voice information in the state structure.

### Example Computing Environment

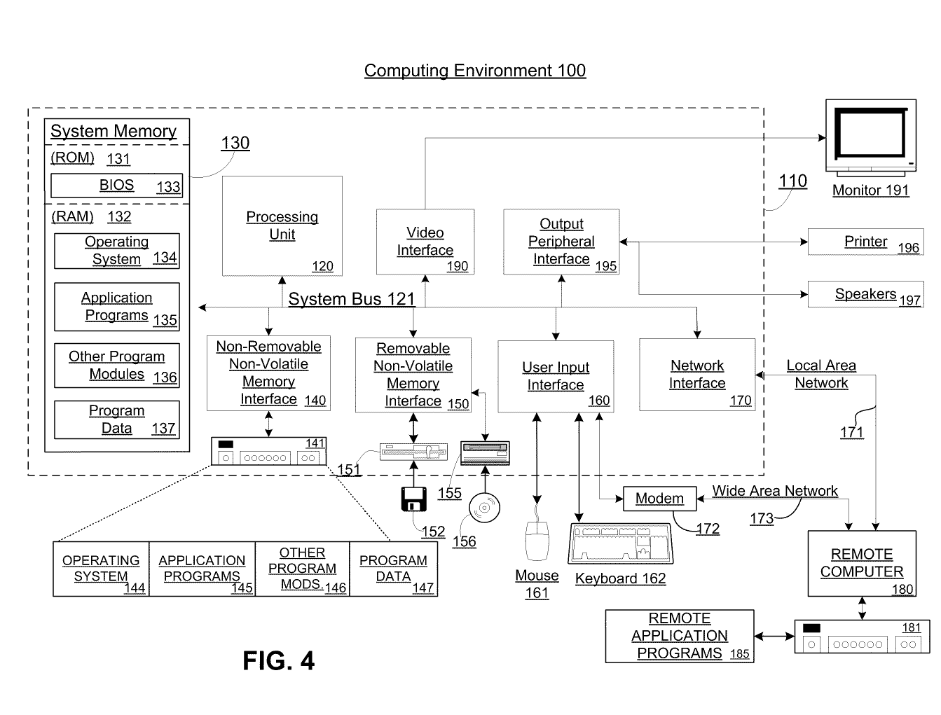

FIG. 4 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137.

The computer 110 may also include other removable/non-removable, volatile/nonvolatile computer storage media. By way of example only, FIG. 4 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 4, provide storage of computer readable instructions, data structures, program modules and other data for the computer 110. In FIG. 4, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted in FIG. 4 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 4 illustrates remote application programs 185 as residing on memory device 181. It will be appreciated that the network connections shown are exemplary and other means of establishing a communications link between the computers may be used.

What is claimed:

1. A method for synchronizing video among a plurality of clients, the method comprising:
designating one, and only one, of the plurality of clients as a remote holder client;
updating a state structure associated with the remote holder client to reflect a change in time code or playback status associated with certain video content; and
communicating the updated state structure associated with the remote holder client to the other clients in the plurality of clients, and
presenting the video content, at each of the plurality of clients, in accordance with the updated state structure of the remote holder client.

2. The method of claim 1, further comprising:
conforming respective state structures associated with each of the other clients to the updated state structure of the remote holder client.

3. The method of claim 2, wherein each of the state structures contains a video identifier, a current playback status indicator, and a current time code associated with the video content.

4. The method of claim 1, wherein the state structure associated with the remote holder client is updated in response to a selection, by a user of the remote holder client, of a playback operation associated with the video content.

5. The method of claim 4, wherein the playback operation is a play, pause, stop, or seek operation.

6. The method of claim 4, wherein the playback operation is a fast-forward or reverse operation.

7. The method of claim 1, wherein the state structure associated with the remote holder client is updated in response to a selection, by a user of a client other than the remote holder client, of a playback operation associated with the video content.

8. The method of claim 7, further comprising:
updating a state structure associated with the client other than the remote holder client to reflect a change in time code or playback status associated with the video content; and
communicating to the remote holder client the updated state structure associated with the client other than the remote holder client.

9. The method of claim 7, further comprising:
updating a state structure associated with the remote holder client to reflect a change in time code or playback status associated with certain video content; and
communicating the updated state structure associated with the remote holder client to the other clients in the plurality of clients.

10. The method of claim 7, wherein the state structure associated with the client other than the remote holder client is updated in response to a selection, by a user of the client other than the remote holder client, of a playback operation associated with the video content.

11. The method of claim 10, wherein the playback operation is a play or pause operation.

12. The method of claim 11, wherein the state structure associated with the client other than the remote holder client is not updated in response to a selection, by a user of the client other than the remote holder client, of a playback operation other than a play or pause operation.

13. A synchronized video system, comprising:
a plurality of client computing devices interconnected via a network, each said client computing device having a respective video display and a respective audio device,
wherein each said client provides a respective user interface on its video display, the user interface including a video presentation portion, via which certain video content is presented, and a respective avatar corresponding to each of the client computing devices,
the video content and avatars being provided in synchronicity among the plurality of client computing devices.

14. The synchronized video system of claim 13, wherein the client computing devices provide synchronized audio via their respective audio devices.

15. The synchronized video system of claim 14, wherein each of the user interfaces includes a respective text chat area via which synchronized text is provided among the plurality of client computing devices.

16. The synchronized video system of claim 14, wherein each of the client computing devices has associated therewith a respective state structure associated with the video content, and synchronicity of the video and the avatars is maintained by conforming the state structure associated with all of the client computing devices to an updated state structure of a specific one of the client computing devices, in response to a selection, by a user of the specific one of the client computing devices, of a playback operation associated with the video content.

17. A synchronized video system, comprising:
a plurality of clients interconnected via a network, wherein one, and only one, of the clients is designated as a remote holder client, and each client has associated therewith a respective state structure associated with certain video content,
wherein the state structure associated with the remote holder client is updated, in response to a selection of a playback operation associated with the video content,
the updated state structure associated with the remote holder client is communicated to the other clients in the plurality of clients,
the respective state structures associated with each of the other clients are conformed to the updated state structure of the remote holder client,
the video content is presented in synchronicity at each of the plurality of clients in accordance with the updated state structures,
each of the clients presents a respective user interface that provides the video content and a respective avatar associated with each of the clients.

18. The system of claim 17, wherein the state structure associated with the remote holder is updated in response to a selection of the playback operation by a user of the remote holder.

19. The system of claim 17, wherein a state structure associated with a client other than the remote holder is updated, in response to a selection of the playback operation by a user of the client other than the remote holder client,
the updated state structure associated with the client other than the remote holder client is communicated to the remote holder, and
the state structure associated with the remote holder is updated to conform to the updated state structure associated with the client other than the remote holder.

20. The system of claim 17, wherein the avatars are presented in synchronicity among the plurality of clients.
